(19) United States
(12) Patent Application Publication
(10) Pub. No.: US 2004/0117223 A1
(43) Pub. Date: Jun. 17, 2004

(54) Water metering system

(76) Inventor: Wade W. Smith, Skillman, NJ (US)

Correspondence Address: Spencer T. Smith, 53 Silver Brook Lane, North Granby, CT, 06060, US

(21) Appl. No.: 10/319,865

(22) Filed: Dec. 13, 2002

(51) Int. Cl. G06F 17/60

(52) U.S. Cl. 705/7

(57) ABSTRACT

A method of monitoring the use of a resource such as water, gas, electricity or energy embedded in a fluid in a unit of a multi-tenant building occupied by a tenant or other consuming entity from the building management entity or owner, the use of the resource being monitored with monitoring technology having a substantial cost and installed by a resource servicing company. An agreement is established between the tenant or other consuming entity and the building management entity or owner including billing terms for the monitored resource(s). An agreement is established between the building management entity or owner and the resource servicing company whereby the resource servicing company will install, operate and service the monitoring technology in the unit, compute and deliver periodic bills to the tenant or other entity for the use of the monitored resources and collect the bills and share the proceeds with the building management entity or owner. And an agreement is established between the resource servicing company and a financing entity whereby the monitoring technology is sold from the resource services company to the financing entity and rented back from the financing entity.

The present invention relates to water submetering systems which are used in commercial buildings or apartment houses or the like where a number of tenants use supplied water resources.

### BACKGROUND OF THE INVENTION

It is believed that when a resource is metered, and the consumer of the metered resource must pay for consumption, use of the resource will decrease. To meter the use of water in an apartment unit, it is necessary to meter water flow through all of the discharge pipes. Individual meters can be located in the pipes which supply a toilet, sink, tub or shower. U.S. Pat. Nos. 5,838,258 and 6,121,100 disclose such a system.

In current systems, the owners of a multi-tenant building purchase efficiency improvements and submetering systems that measure the utility consumption of each tenant individually. On a periodic basis (monthly, or often in the case of electricity, hourly), the meters are read and the tenants are billed for their consumption. Often the owner purchases the services of a metering services company which reads the meters, prepares and delivers tenant bills, collects the payments and remits the collections to the owner, less their metering service fee. The cost of such systems impedes their implementation since the cost is substantial, capital is often unavailable and the payback is gradual.

Attempts have been made to overcome this problem in the laundry services industry, by having the laundry service company share coin-operated laundry revenue with building owners in two respects:

1. Laundry service providers retain ownership of installed laundry equipment, and

2. Laundry service providers share revenue as rent for the space their equipment occupies.

### OBJECT OF THE INVENTION

It is accordingly an object of the present invention to provide a structure which will facilitate the infusion of required cash to drive the installation of submetering and other efficiency improving technology.

It is a further object of the present invention to enable the owner to install systems which will secure the reduction and recovery of expenses associated with water/energy consumption without incurring the cost of the required systems.

Other objects and advantages of the present invention will become apparent from the following portion of this specification and from the accompanying drawings which illustrate, in accordance with the mandate of the patent statutes, a presently preferred embodiment incorporating the principles of the invention.

### BRIEF DESCRIPTION OF THE DRAWINGS

FIG. 1 is a schematic illustration of a unit of a multi-tenant building having a number of water devices which are individually metered;

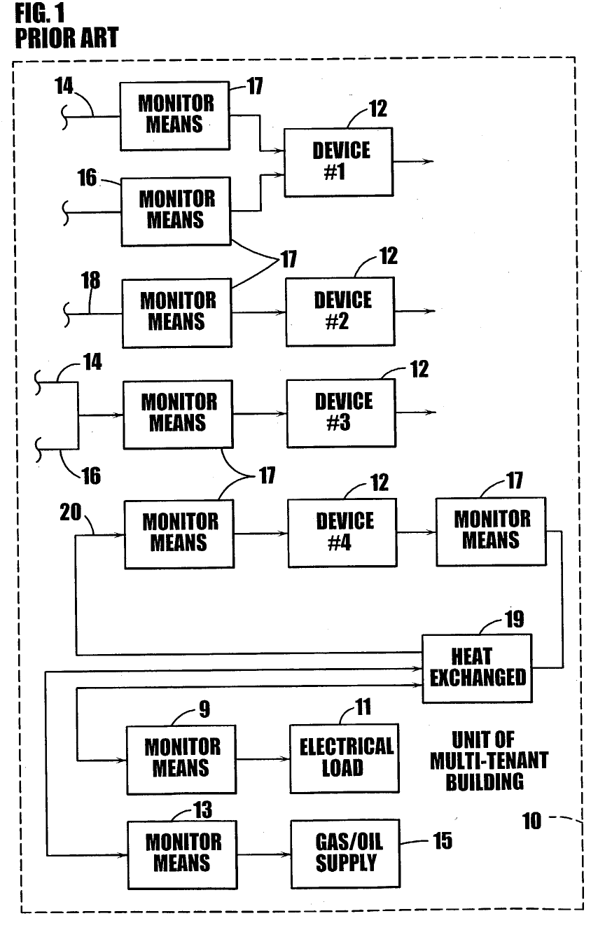

FIG. 2 is a schematic illustration of a prior art installation of Monitor Means shown in FIG. 1;

FIG. 3 is a schematic illustration showing of the cash generation structure for funding the installation of systems such as illustrated in FIG. 1; and

FIG. 4 is a schematic drawing illustrating how the Resource Servicing Company can subcontract some of its responsibilities.

### BRIEF DESCRIPTION OF THE PREFERRED EMBODIMENT

A unit of a multi-tenant building (an apartment or unit in a commercial building) 10 has one or a number of water and/or energy consuming Devices 12. Device #1 could be a sink such as a kitchen sink or a bathroom sink or a tub/shower which discharges water and which has separate hot 14 and cold 16 water lines on which a Monitor Means 17 could be mounted. Device #2 could be a toilet, for example, which discharges water and which has only one water line 18. Device #3 could be a sink/tub where metering is possible following the merger of the hot 14 and cold 16 water lines. Device #4 could be a closed loop 20 hot water heater/cooler where water is heated in a heat exchanger 19 which may either use an Oil/Gas Supply 15 (Monitor Means 13 measuring the flow) or an Electric Lead 11 (Monitor Means 9 measuring the electricity use) as the heating/cooling medium. Alternately, Monitor Means 17 could be located on either side of the device. A unit in a multi-tenant building may have any number of such devices.

The Monitor Means 17 may be of the type disclosed in U.S. Pat. No. 5,969,267 wherein an impeller located within the flow stream rotates with flow and a target on the impeller is monitored by a sensor which inputs sensing information into a processor. The Monitor Means could also be of a type which could determine flow without being located within the pipe, or one that monitors electrical use or load (Monitor Means 9), gas (oil) use (Monitor Means 13) or energy embedded in another medium such as water. The Monitor Means may also have temperature sensing capability.

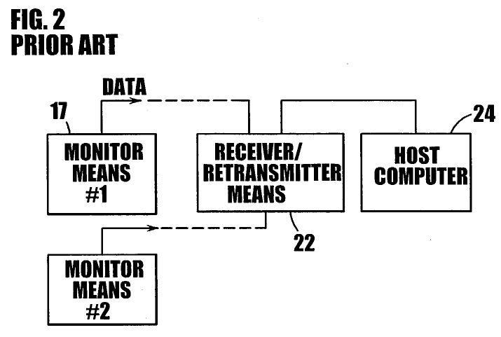

In a conventional system (FIG. 2), a Monitor Means such as Monitor Means 17 transmits data relevant to the calculation of cost for the resource used via an RF transmitter to a Receiver/Transmitter Means 22 which may be located within the building. The Receiver/Transmitter periodically receives data from a number of Monitor Means and periodically retransmits this collected data to a Host Computer 24 which calculates the use and its cost. Alternate technologies can be used either between the Monitor Means and the Receiver/Transmitter or between the Receiver/Transmitter and the Host Device, such as hard wire, phone, radio or the like.

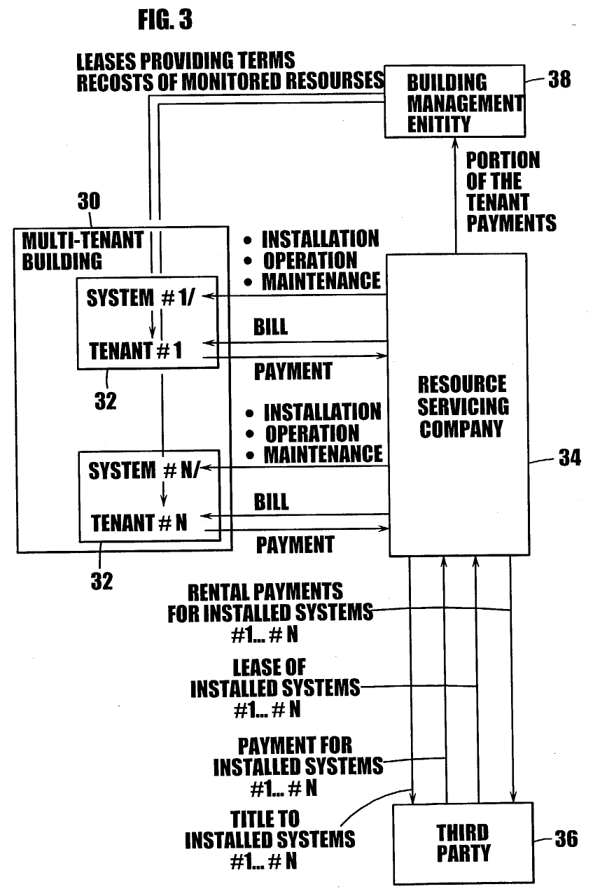

FIG. 3 illustrates a Multi-Unit Building 30 having a number of Systems/Tenants 32. A Resource Servicing Company 34, is responsible for the Installation, Maintenance and Operation of System #1 . . . , System #N in the Multi-Tenant Building and directs a periodic Bill, for the use of the resource monitored, to the associated Tenant #1 . . . , Tenant #N (the Building Management Entity (owner) includes in rental agreements/leases/legal agreements with tenants (consuming entities) in the apartment/commercial building the billing procedure which is based on use of the resource within the unit). These tenants (or other entity) then make Payment responsive to these bills.

The Resource Servicing Company 34, which develops, manufactures, installs and services the systems, sells these installed systems (Title To Installed Systems #1 . . . #N) to a Third Party 36 which makes Payment For Installed Systems #1 . . . #N to the Resource Servicing Company. The Third Party 36 enters into a Lease Of Installed Systems #1 . . . #N with the Resource Servicing Company which then makes Rental Payments For Installed Systems #1 . . . #N to the Third Party. The Third Party can Amortize the owned inventory and the rental payments can be defined to secure for the Third Party a cost plus X % return. The Resource Servicing Company, by agreement with the Building Management Entity 38, bills tenants, etc. collects payments, retains a service fee, makes the rental payments to the Third Party and pays the Building Management Entity or owner a defined Portion of the Payments collected.

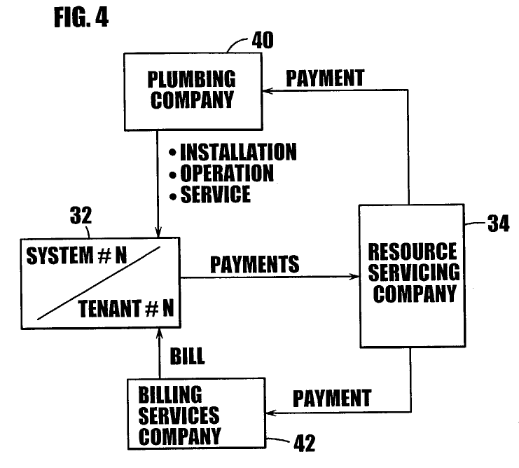

As shown in FIG. 4, the Resource Servicing Company 34 may subcontract out one or more of its responsibilities. For example, the Resource Servicing Company may with some form of Payment, retain a Plumbing Company 40 to perform the Installation/Operation/Maintenance functions and the Resource Servicing Company may with some form of Payment, retain a Billing Services Company 42 to perform the computation and billing functions and to perform the meter reading function where required. Optionally, the Billing Services Company could additionally be responsible for collecting the payments and the distribution of funds from the Resource Servicing Company would reflect that relationship.

1. A method of monitoring the use of a resource such as water, gas, electricity or energy embedded in a fluid in a unit of a multi-tenant building leased by a tenant from the building management entity or owner, the use of the resource being monitored with monitoring technology having a substantial cost and installed by a resource servicing company, comprising establishing a legal agreement between the tenant and the building management entity or owner including billing terms for the monitored resource(s),
establishing an agreement between the building management entity or owner and the resource servicing company whereby the resource servicing company will install, operate and maintain the monitoring technology in the unit, compute and deliver periodic bills to the tenant for the use of the monitored resources and collect the bills and share the proceeds with the building management entity or owner,
establishing an agreement between the resource servicing company and a financing entity whereby the monitoring technology is sold from the resource servicing company to the financing entity and rented back from the financing entity.

2. A method of monitoring the use of a resource such as water, gas, electricity or energy embedded in a fluid according to claim 1, wherein the resource servicing company enters into an agreement with a plumbing company to install, operate and maintain the monitoring technology in the unit.

3. A method of monitoring the use of a resource such as water, gas, electricity or energy embedded in a fluid according to claim 1, wherein the resource servicing company enters into an agreement with a billing services company to compute the bill for the tenant for the used resource(s).

4. A method of monitoring the use of a resource such as water, gas, electricity or energy embedded in a fluid according to claim 1, wherein the monitored and billed resource is water discharged by the tenant.

5. A method of monitoring the use of a resource such as water, gas, electricity or energy embedded in a fluid according to claim 1, wherein the monitored and billed resource is heat/cooling energy used by the tenant to heat/cool occupied space.

6. A method of monitoring the use of a resource such as water, gas, electricity or energy embedded in a fluid according to claim 1, wherein the resource servicing company enters into an agreement with a meter reading company to compute the bill for the tenant for the used resource(s).
